(19) United States
(12) Patent Application Publication
(10) Pub. No.: US 2026/0099578 A1
(43) Pub. Date: Apr. 9, 2026

(54) Method and Apparatus for Logging into System Using Smart Key Device

(71) Applicant: Feitian Technologies Co., Ltd., Beijing (CN)

(72) Inventors: Zhou Lu, Beijing (CN); Huazhang Yu, Beijing (CN)

(73) Assignee: Feitian Technologies Co., Ltd., Beijing (CN)

(21) Appl. No.: 19/380,513

(22) Filed: Nov. 5, 2025

Related U.S. Application Data
(63) Continuation-in-part of application No. 17/834,689.

(30) Foreign Application Priority Data
Jul. 14, 2020 (CN) 202010671810.5

(51) Int. Cl. G06F 21/34; G06F 21/32; G06F 21/33

(52) U.S. Cl. CPC G06F 21/34; G06F 21/32; G06F 21/33

(57) ABSTRACT

Method for performing dual verification to login into a Windows operating system, wherein in the case that a first function of a device driver is invoked by the Windows operating system, initializing, by the device driver, a first data structure; storing a second data structure self-defined in the first data structure; returning the first data structure to the Windows operating system; and in the case that a sixth function of the device driver is invoked, popping up, by the device driver, a verification box according to a login interface window handle in the second data structure, prompting a user to input both a PIN code and biological feature information. The present invention makes the user to conveniently verify his/her identity via both PIN code and biological feature when the user safely logins into the Windows operating system.

### CROSS REFERENCE TO RELATED APPLICATION

This application is a continuation-in-part (CIP) application, whose parent application is with a filing date of Jun. 7, 2022, an application number of U.S. Ser. No. 17/834,689, and a title of “Method and Apparatus for Logging into System Using Smart Key Device”.

### FIELD OF THE INVENTION

The present invention relates to a method for logging in a Windows operating system of Personal Computer (PC) by a smart key, which belongs to a field of information security.

### PRIOR ART

In prior art, a verification and login of a user's identity is finished via interaction between an operating system and a smart key, there are two modes of verification at the moment, one of them is that a PIN code input by a user is verified via a smart key, the other is that the biological feature input by a user is verified via a smart key; but, the operating system only supports one of the two methods during the verification, that is not safe; thus, a safer way to log in an operating system is needed.

### SUMMARY OF THE INVENTION

The object of the present invention is to provide a method for performing dual verification to login into a Windows operating system, which makes a login by the smart key safer.

Thus, according to one respect of the present invention, there is provided a method for performing dual verification to login into a Windows operating system by a smart key, wherein the method is implemented using a device driver of the smart key, in which the device driver comprises a first function, a fourth function, a fifth function, a sixth function, a seventh function and an eighth function, the method comprises:
in the case that login triggering information is received, prompting, by the Windows operating system, a user to insert the smart key;
in the case that the smart key is detected, invoking, by the Windows operating system, the first function;
in the case that the first function of the device driver is invoked by the Windows operating system, initializing, by the device driver, a first data structure, obtaining a fourth function address, a fifth function address, a sixth function address, a seventh function address and an eighth function address, building a second data structure which is defined by a manufacturer itself and storing the second data structure in the first data structure, and returning the first data structure to the Windows operating system;
in the case that the fourth function of the device driver is invoked by the Windows operating system, sending, by the device driver, an instruction for obtaining a login verification mode which is used to determine whether both a fingerprint and a PIN are verified to the smart key during a login process of the Windows operating system to the smart key, receiving the verification mode information returned from the smart key, and organizing, by the device driver, the verification mode information into a fifth data structure and returning the fifth data structure to the Windows operating system;
in the case that the fifth function of the device driver is invoked, obtaining, by the device driver, a login interface window handle in a fifth function parameter, storing the login interface window handle into the second data structure, and returning an invoking response value to the Windows operating system;
in the case that the sixth function of the device driver is invoked by the Windows operating system, popping up, by the device driver, a verification box according to the login interface window handle in the second data structure, prompting the user to input a PIN code, and sending an instruction for verifying the PIN code to the smart key when the PIN code input by the user is received;
in the case that the device driver receives PIN code verified result data returned from the smart key, determining, by the device driver, whether the PIN code is verified successfully, if yes, prompting the user to further input biological feature information into the smart key for verification, and sending an instruction for verifying a biological feature to the smart key; otherwise, prompting the PIN code is verified unsuccessfully;
in the case that the device driver receives the biological feature verified result data returned from the smart key, determining, by the device driver, whether the biological feature is also verified successfully, if yes, returning verification successful information to the Windows operating system; otherwise, prompting the biological feature is verified unsuccessfully;
in the case that the seventh function of the device driver is invoked by the Windows operating system, sending, by the device driver, data to be signed to the smart key, receiving signed data returned from the smart key, and organizing the signed data into credential information, and returning the credential information to the Windows operating system; and
in the case that the eighth function of the device driver is invoked by the Windows operating system, sending, by the device driver, encrypted data to the smart key, receiving decrypted data returned from the smart key, and organizing the decrypted data into verified data, and returning the verified data to the Windows operating system; and
in the case that the verified data is verified successfully, permitting, by the Windows operating system, logging into the Windows operating system as the user.

Preferably, the method further comprises: obtaining, by the device driver, a verification policy identification from the received verification mode information returned from the smart key, and determining whether the verification policy identification is a biological feature verification according to the verification policy identification, if yes, setting a verification type as a first preset value; otherwise, setting a verification type as a second preset value, and organizing the fifth data structure according the set verification type, and returning the fifth data structure to the Windows operating system, so as to the Windows operating system can organize the login interface window handle according to the verification type in the fifth data structure.

Preferably, the method further comprises: in the case that a third function of the device driver is invoked by the Windows operating system, sending, by the device driver, an instruction for obtaining public key information of an appointed index container to the smart key according to an input or introduced parameter, receiving the public key information returned from the smart key, and organizing the public key information into a fourth data structure, and returning the fourth data structure to the Windows operating system.

Preferably, the method further comprises: in the case that a second function of the device driver is invoked by the Windows operating system, obtaining, by the device driver, a file name of the input or introduced parameter, sending an instruction for obtaining file information to the smart key according to the file name, receiving the file information returned by the smart key, and organizing a third structure data according to the file information and returning the third structure data to the Windows operating system.

Preferably, the method further comprises: obtaining, by the device driver, the file name of the input or introduced parameter, determining the obtained file name, sending, by the device driver, an instruction for obtaining a smart key serial number to the smart key according to a first file name, receiving first file information returned from the smart key, obtaining a serial number in the first file information, and organizing the third data structure according to the serial number and returning the third data structure to the Windows operating system in the case that the file name is the first file name.

Preferably, the method further comprises: obtaining, by the device driver, an input introduced parameter file name, determining the obtained file name, sending, by the device driver, an instruction for obtaining a certificate stored in the smart key to the smart key according to a second file name in the case that the file name is the second file name, receiving the certificate information returned from the smart key, and organizing the obtained certificate information into a third data structure and returning the third data structure to the Windows operating system.

Preferably, the method further comprises: obtaining, by the device driver, the input or introduced parameter file name, determining the obtained file name, and organizing, by the device driver, an obtained certificate content into a data structure and returning the data structure to the Windows operating system in the case that the file name is a third file name.

Preferably, the Windows operating system is running on a Personal Computer.

Preferably, the device drive is a minidriver of the smart key.

Preferably, the second data structure is self-defined to provide the login interface window handle to the sixth function.

Preferably, the second data structure is self-defined by manufacturer of the smart key to provide the login interface window handle to the sixth function.

Preferably, the verification box popped up by the device driver comprising a text information prompting the user to input the PIN code and the biological feature information during the login process of the Windows operating system.

According to the other aspect of the present invention, there is provided a method for performing dual verification to login into a Windows operating system by a smart key, wherein the method is implemented using a minidriver of the smart key, the method comprises:
in the case that a (′ardAcquireContext function of the minidriver is invoked by the Windows operating system, initializing, by the minidriver, a first data structure, building a second data structure which is self-defined and storing the second data structure in the first data structure, and returning the first data structure to the Windows operating system;
in the case that a (′ardAuthenticateEx function of minidriver is invoked by the Windows operating system, popping up, by the minidriver, a verification box according to the login interface window handle in the second data structure, prompting the user to input a PIN code and a biological feature information
in the case that the PIN code and the biological feature information are verified successfully, the verified data is verified successfully, permitting, by the Windows operating system, logging into the Windows operating system.

Preferably, the second data structure is self-defined by manufacturer of the smart key to provide the login interface window handle to the CardAcquireContext function.

Preferably, the verification box popped up by the minidriver comprising a text information prompting the user to input the PIN code and the biological feature information during login process of the Windows operating system.

Alternatively, according to one respect of the present invention, there is provided a method for logging in the system by the smart key, comprising:
in the case that a fourth function of the device is invoked, the device sending an instruction for obtaining login verified mode to the smart key, receiving verified mode information returned from the smart key, and the device organizes the verified mode information into a fifth data, and returning the fifth data to the operating system;
in the case that a fifth function of the device is invoked by the operating system, the device obtaining a login interface window handle from the fifth function, storing the login interface window handle into a second data structure, and returning an invoking response value to the operating system;
in the case that a sixth function of the device is invoked by the operating system, popping a verification box according to the login interface window handle in the second data structure, prompting a user to input PIN code, and sending an instruction for verifying PIN code to the smart key when the PIN code input by the user is received;
in the case that the device receives a PIN code verified result data which is returned from the smart key, the device determining whether the PIN code is verified successfully, if yes, prompting the user input biological feature information in the smart key for verification, and sending an instruction for verifying biological feature to the smart key; otherwise, prompting that the PIN code is verified unsuccessfully;
in the case that the device receives the biological feature verified result data returned from the smart key, determining, by the device, whether the biological feature is verified successfully, if yes, returning verification successful information to the operating system; otherwise, prompting the biological feature is verified unsuccessfully;
in the case that a seventh function of the device is invoked by the operating system, the device sending the data being signed to the smart key, receiving signed data returned from the smart key, the device organizing the signed data into credential information and returning the credential information to the operating system; and
in the case that an eighth function of the device is invoked by the operating system, the device sending encrypted data to the smart key, receiving decrypted data returned from the smart key, and the device organizing the decrypted data into verified data and returning the verified data to the operating system.

According to the other aspect of the present invention, there is provided a device for logging in a system by a smart key, comprising:
a fourth operation module, a fifth operation module, a sixth operation module, a seventh operation module, an eighth operation module;
the fourth operation module is configured to send an instruction for obtaining login verified mode to the smart key, to receive verified mode information returned from the smart key, and to organize the verified mode information into fifth data structure, and to return the fifth data to the operating system;
the fifth operation module is configured to obtain login interface window handle from fifth function, and to store the login interface window handle into a second data structure, and return an invoking response value to the operating system;
the sixth operation module is configured to pop a verification box according to the login interface window handle in the second data structure stored by the fifth operation module, and to prompt the user to input PIN code, and to receive the PIN code input by the user, and to send verifying PIN code instruction to the smart key;
the sixth operation module is configured to receive PIN code verified result data which is returned from the smart key, and to determine whether the PIN code is verified successfully, if yes, to prompt the user to input biological feature in the smart key for verification, and to send instruction for verifying biological feature to the smart key; otherwise, to prompt the PIN code is verified unsuccessfully;
the sixth operation module is further configured to receive the biological feature verified result data returned from the smart key, and to determine whether the biological feature is verified successfully, if yes, to return verified successfully information to the operating system; otherwise, to prompt the biological feature verified unsuccessfully;
the seventh operation module is configured to send the data being signed to the smart key, and to receive the signed data returned from the smart key, and to organize the signed data into credential information, and to return the credential information to the operating system; and
the eighth operation module is configured to send the encrypted data to the smart key, and to receive decrypted data returned from the smart key, and to organize the decrypted data into verified data and to return the verified data to the operating system.

According to the present invention, it obtains verification mode supported by the smart key via the device driver, returns verification type to the operating system according to verification mode, in this way, the operating system organizes the login interface window handle according to the verification type, and the device driver receives the login interface window handle sent from the operating system, pops up a verification box according to the login interface window handle, prompts a user to verify both the PIN code and the biological information. Thus, in the present invention, when login, the user identify is conveniently verified via both the PIN code and the biological feature to make the login safer.

### BRIEF DESCRIPTION OF THE DRAWINGS

FIG. 1 shows a method for performing dual verification to login into a Windows operating system.

FIG. 2 is a flow diagram of a method for logging into a system by a smart key according to Embodiment 1 of the present invention;

FIG. 3-1 and FIG. 3-2 are a flow diagram of a method for logging into a system by a smart key according to Embodiment 2 of the present invention; and

FIG. 4 is a block diagram of device for logging into a system by a smart key;

FIG. 5 shows a verification box according to the present invention, prompting a user to input both a PIN code and a biological feature information.

FIG. 6 shows how a fifth function is used.

FIG. 7 shows how a sixth function is used.

### EMBODIMENTS FOR CARRYING OUT THE INVENTION

The technical solution in the Embodiments of the present invention is further described more clearly and completely together with the drawings of the present invention. Apparently, Embodiments described herein are just a few Embodiments of the present invention. On the basis of Embodiments of the invention, all other related Embodiments made by those skilled in the art without any inventive work belong to the scope of the invention.

A Smart Card (e.g., a smart key) consists of one or more integrated circuit chips and is packaged in a form of a card or a hardware device that is convenient for people to carry. The integrated circuit in the Smart Card includes CPU, storage devices, such as PROM (Programmable Read-Only Memory), RAM (Random Access Memory), and ROM (Read-Only Memory). The smart card interface conforms to those interface specifications such as ISO7816-3 and ISO7816-12, and can also include COS (Card/Chip Operating System). Smart cards have temporary or permanent data storage capacity, and also have logic processing function, which is used to identify and respond to externally provided information and execute instructions. A smart key, one of smart card device, in terms of a software function structure, can also include a minidriver component.

A Smart card can integrate biometric technology and PIN technology, and at the same time, it can collect and compare fingerprints in the smart card. All fingerprint algorithms of the smart card can be executed in an internal chip, and important data such as certificates can be stored in an encryption chip.

The term “device driver” (or simply called “device”) refers to a driver software installed in the Windows operating system, e.g., a minidriver.

### Minidriver Consists of Many Interfaces

FIG. 5 is shows a login interface according to the minidriver.

A first function of the present invention can be “CardAcquireContext”, returning a first data structure PCARD_DATA, which is updated to include a second data structure CARDPRIVATEDATA.

A second function of the present invention can be “CardReadFile”.

A third function of the present invention can be “CardGetContainerInfo”, returning a fourth data structure CONTAINER INFO.

A fourth function of the present invention can be “CardGetProperty”, returning a fifth data structure PIN INFO.

A fifth function of the present invention can be “CardSetProperty”, saving a parent window handle.

A sixth function of the present invention can be “CardAuthenticeEx”, popping up a login interface to verify both a PIN and a fingerprint.

A seventh function of the present invention can be a signature function “CardSignData”, so that the Windows operating system allows login in after verifying a signature successfully.

The function “CardGetProperty” is defined in Windows, but its functionality is implemented by the inventors.

The second data structure “CARDPRIVATEDATA” is defined or customized by the inventors as follows:

typedef struct_card_private_data

| | |
|---|---|
| { | |
| PVOID | pvVendorSpecific; |
| HWND | parentWindow; //Parent window handle |
| CARD_AUTHENTICATE_RESPONSE | sessionPin; |

}CARDPRIVATEDATA, *PCARDPRIVATEDATA;

The term ‘first data structure’ is defined in Windows and is a structure in the minidriver.

The verification of the PIN and the fingerprint is implemented by mean of the sixth function;

When calling the sixth function, a verification box pops up according to the six function to verify both the PIN and the fingerprint. The window handle used for the verification box is “parentWindow” in the second data structure.

The present invention verifies both a PIN and a fingerprint simultaneously, having an additional security verification over the prior art.

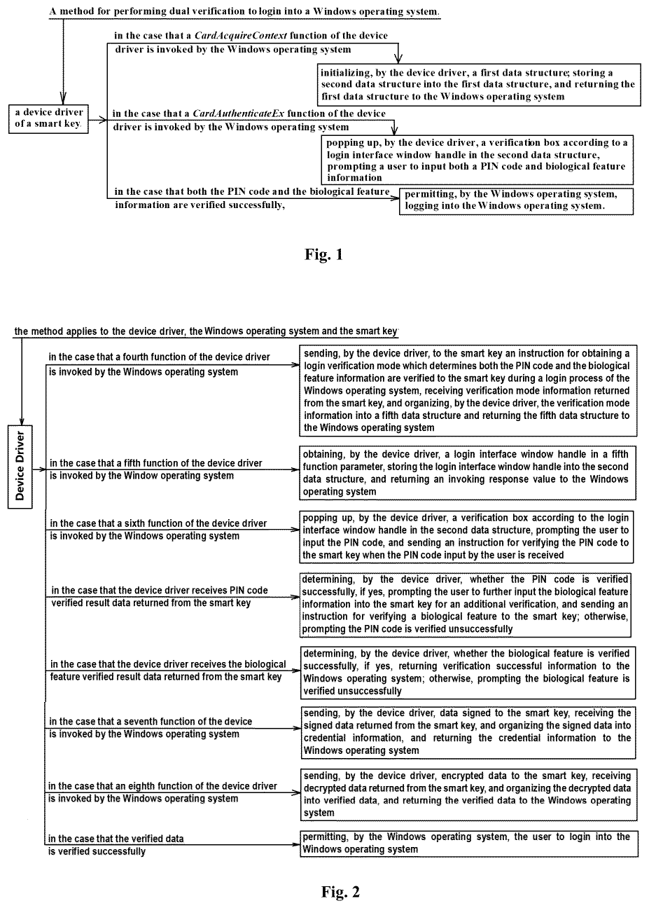

As shown in FIG. 1, there is provided a method for performing dual verification to login into a Windows operating system, wherein the method is implemented using a device driver of a smart key, the method comprises:
in the case that a first function of the device driver is invoked by the Windows operating system, initializing, by the device driver, a first data structure; storing a second data structure into the first data structure, and returning the first data structure to the Windows operating system;
in the case that a sixth function of the device driver is invoked by the Windows operating system, popping up, by the device driver, a verification box according to a login interface window handle in the second data structure, prompting a user to input both a PIN code and biological feature information; and
in the case that both the PIN code and the biological feature information are verified successfully, permitting, by the Windows operating system, logging into the Windows operating system.

### Embodiment 1

According to Embodiment 1 of the present invention, a method applies to a device driver, an operating system, and a smart key, as shown in FIG. 2, comprising:
in the case that a fourth function is invoked by the operating system, the device driver sends an instruction for obtaining a login verified mode to the smart key, receives verified mode information returned from the smart key, and organizes the verified mode information into a fifth data structure and returns the fifth data structure to the operating system;
in the case that a fifth function of the device driver is invoked by the operating system, the device driver obtains a login interface window handle from the fifth function parameter, and stores the login interface window handle into a second data structure, and returns information to the operating system;
in the case that a sixth function of the device driver is invoked by the operating system, the device driver pops up a verification box according to the login interface window handle in the second data structure, prompts a user to input a PIN code, and sends a verifying PIN code instruction to the smart key when the PIN code input by the user is received;
in the case that the device driver receives PIN code verified result data which is returned from the smart key, the device driver determines whether the PIN code is verified successfully, if yes, prompts the user to input biological feature information in the smart key for an additional verification, and sends a verifying biological feature instruction to the smart key; otherwise, prompts the PIN code is verified unsuccessfully;
in the case that the device driver receives biological feature verified result data returned from the smart key, determines whether the biological feature is verified successfully, if yes, returns verified successfully information to the operating system; otherwise, prompts that biological feature is verified unsuccessfully;
in the case that a seventh function of the device driver is invoked, the device driver sends data being signed to the smart key, receives the signed data returned by the smart key, and the device driver organizes the signed data into credential information and returns the credential information to the operating system;
in the case that an eighth function of the device driver is invoked, the device driver sends encrypted data to the smart key, receives decrypted data returned from the smart key, and the device driver organizes the decrypted data into verified data and returns the verified data to the operating system.

Preferably, in Embodiment 1, the device driver organizing the verified mode information into the fifth data structure, and returning the fifth data structure to the operating system specifically is that the device driver obtains a verifying policy identification from the verified mode information returned from the smart key, and determines whether the verified mode is a biological feature verified mode according to the verifying policy identification, if yes, sets the verified mode as a first preset value; otherwise, sets the verified mode as a second preset value, organizes the fifth data structure according to the verified mode, and returns the fifth data structure to the operating system.

Preferably, in Embodiment 1, the method further includes that the device driver sends an instruction for obtaining public key information of an appointed index container to the smart key according to an input parameter, and receives the public key information returned from the smart key, and organizes the public key information as the fourth data structure and returns the fourth data structure to the operating system in the case that a third function of the device driver is invoked by the operating system.

Preferably, in Embodiment 1, the method further includes that the device driver obtains an input parameter file name, sends an instruction for obtaining file information to the smart key according to the file name, and receives the file information returned from the smart key, and organizes the third data structure according to the file information and returns the third data structure to the operating system in the case that a second function of the device driver is invoked.

Preferably, in Embodiment 1, the device driver obtaining the input parameter file name, sending the instruction for obtaining the file information to the smart key according to the file name, and receiving the file information returned from the smart key, and organizing the third data structure according to the file information and returning the third data structure to the operating system specifically includes that
the device driver obtains the input parameter file name and determines the file name, the device driver sends an instruction for obtaining a smart key serial number to the smart key according to a first file name, and receives first file information returned from the smart key, and obtains the serial number from the first file information, and organizes the third data structure according to the serial number and returns the third data structure to the operating system in the case that the file name is a first file name.

Preferably, in Embodiment 1, the device driver obtaining the input parameter file name, and sending the instruction for obtaining the file information to the smart key according to the file name, receiving the file information returned from the smart key, and organizing the third structure data according to the file information and returning the third structure data to the operating system specifically includes that
the device driver obtains the input parameter file name, determines the obtained file name, and sends an instruction for obtaining a certificate stored in the smart key to the smart key, receives certificate information returned from the smart key, and organizes the certificate information into the third data structure and returns the third data structure to the operating system in the case that the file name is a second file name.

Preferably, in Embodiment 1, the device driver obtaining the input parameter file name, sending the instruction for obtaining file information to the smart key according to the file name, and receiving the file information returned from the smart key, and organizing the file information into the third structure data and returning the third structure data to the operating system specifically includes that
the device driver obtains the input parameter file name, determines the file name obtained, and organizes a certificate content into a data structure and returns the data structure to the operating system if the file name is a third file name.

Preferably, in Embodiment 1, the method further includes that the device driver returns a function address list to the operating system when a first function of the device driver is invoked by the operating system.

Preferably, in Embodiment 1, the device driver returning the function address list to the operating system specifically is that the device driver initializes a first data structure, obtains a second function address, a third function address, a fourth function address, a fifth function address, a sixth function address, a seventh function address, and an eighth function address, constructs a second data structure which is defined by an developer itself and stores the second data structure into the first data structure, and returns the first data structure to the operating system.

### Embodiment 2

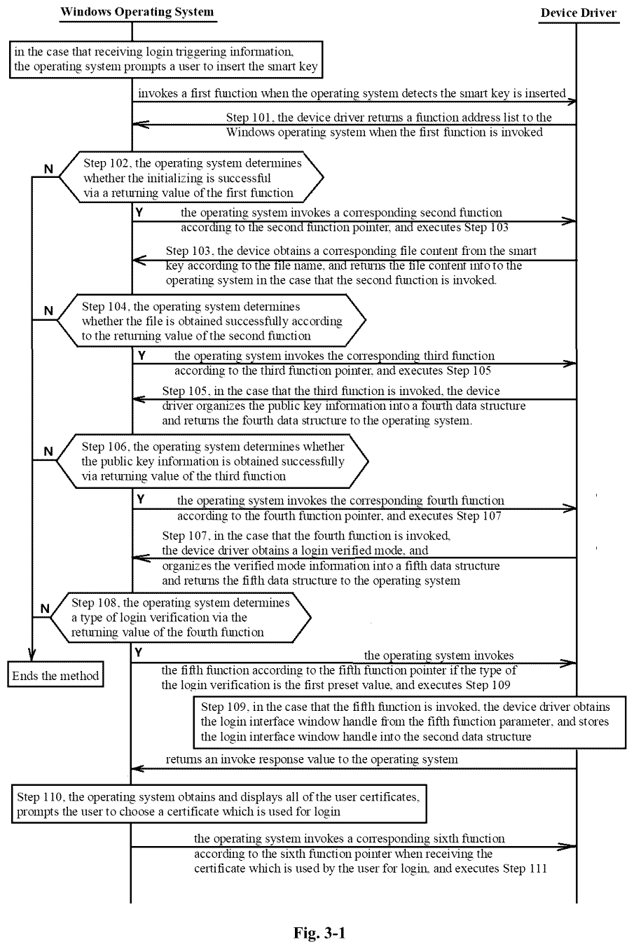

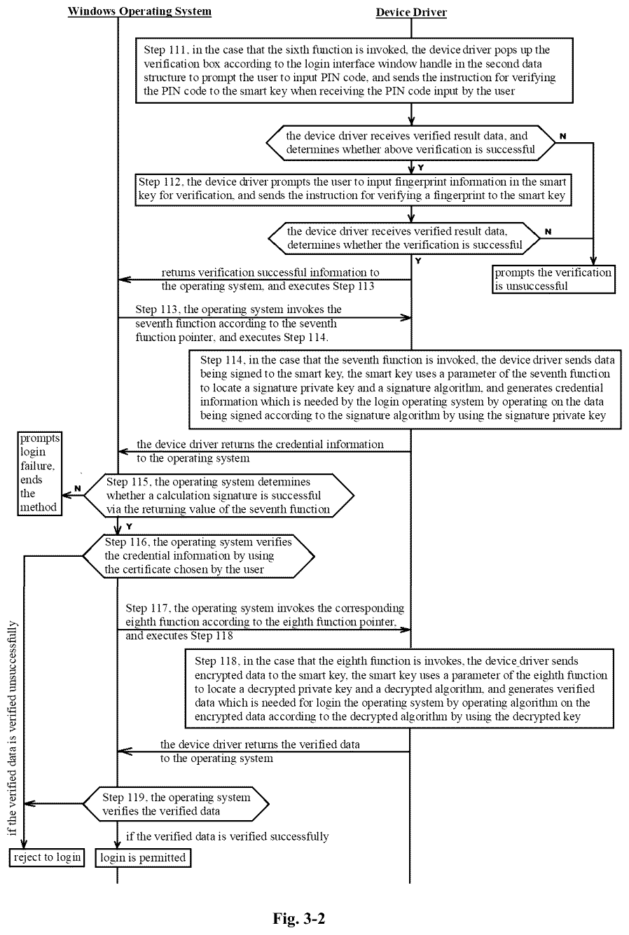

According to Embodiment 2, a method applies to a device driver, a Windows operating system and a smart key, as shown in FIG. 3-1 and FIG. 3-2, including:
in the case that receiving login triggering information, the operating system prompts a user to insert the smart key; and invokes a first function when the operating system detects the smart key is inserted;

Step 101, the device driver returns a function address list to the Windows operating system when the first function is invoked;
specifically, in Embodiment 2, the first function is CardAcquireContext, in which, an input parameter includes a first data structure; the device driver returning the function address list to the operating system includes that initializing a first data structure, obtaining a second function address, a third function address, a fourth function address, a fifth function address, a sixth function address, a seventh function address, and an eighth function address, constructing a second data structure which is defined by a manufacturer itself, and storing the second data structure into the first data structure; the operating system invokes a corresponding function according to the second function address, the third function address, the fourth function address, the fifth function address, the sixth function address, the seventh function address and the eighth function address; preferably, the second function address, the third function address, the fourth address function, the fifth address function, the sixth function address, the seventh function address and the eighth function address are a second function pointer, a third function pointer, a fourth function pointer, a fifth function pointer, a sixth function pointer, a seventh function pointer and an eighth function pointer, respectively.

Step 102, the operating system determines whether the initializing is successful via a returning value of the first function, if yes, the operating system invokes a corresponding second function according to the second function pointer, and executes Step 103; otherwise, ends the method.

In Embodiment 2, Step 102 specifically is that the operating system determines the returning value of the first function, the initializing is successful if the returning value is the function address list; otherwise, the initializing fails.

Step 103, the device obtains a corresponding file content from the smart key according to the file name, organizes the file content into the third structure data and returns the third structure data to the operating system in the case that the second function is invoked.

Specifically, in Embodiment 2, the second function is CardReadFile, the input parameter includes the file name; in which, the first name is CardID, the second name is Cmapfile, the third name is cardcf, kxc00, and kxc01.

Preferably, the device driver obtaining a corresponding file content according to the file name and returning the file content to the operating system specifically is that the device driver obtains the input parameter file name, determines the file name, the device driver executes Step A1 if determining the file name is the first name; the device driver executes Step A2 if determining the file is the second name; and the device driver executes Step A3 if determining the file name is the third name.

Step A1, the device driver sends the instruction for obtaining smart key serial number to the smart key, and organizes received serial number into data structure and returns the data structure to the operating system; Step A2, the device driver sends instruction for obtaining a certificate stored in the smart key to the smart key, determines whether certificate information returned from the smart key is received, if yes, organizes the obtained certificate information into the data structure and returns the data structure to the operating system; otherwise, ends the method.

Specifically, in Embodiment 2, the certificate information specifically includes a number of certificates, a key type, a length, and a function, etc.;
in which, the data structure CMapFile organized from the certificate information is:

```
typedef struct _CONTAINER_MAP_RECORD
{
  WCHAR wszGuid [MAX_CONTAINER_NAME_LEN + 1];
  BYTE bFlags;
  BYTE bReserved;
  WORD wSig smart key SizeBits;
  WORD w smart key Exchange smart key SizeBits;
} CONTAINER_MAP_RECORD, *PCONTAINER_MAP_RECORD;
```

Step A3, the device driver organizes the obtained certificate content into the data structure and returns the data structure to the operating system.

Step 104, the operating system determines whether the file is obtained successfully according to the returning value of the second function, if yes, the operating system invokes the corresponding third function according to the third function pointer, and executes Step 105; otherwise, ends the method.

Step 105, in the case that the third function is invoked, the device driver sends an instruction for obtaining public key information of an appointed index container to the smart key according to the input parameter, receives the public key information returned from the smart key, and organizes the public key information into a fourth data structure and returns the fourth data structure to the operating system.

Specifically, in Embodiment 2, the third function is CardGetContainerInfo;
the system input parameter is an appointed index container identification;
for instance, the fourth data structure ContainerInfo is

```
typedef struct _CONTAINER_INFO
{
  DWORD dwVersion;
  DWORD dwReserved;
  DWORD cbSigPublic smart key;
  PBYTE pbSigPublic smart key;
  DWORD cb smart key ExPublic smart key;
  PBYTE pb smart key ExPublic smart key;
} CONTAINER_INFO, *PCONTAINER_INFO;
```

Step 106, the operating system determines whether the public key information is obtained successfully via returning value of the third function, if yes, the operating system invokes the corresponding fourth function according to the fourth function pointer, and executes Step 107; otherwise, ends the method.

Step 107, in the case that the fourth function is invoked, the device driver sends an instruction for obtaining a login verified mode to the smart key, receives verified mode information returned from the smart key, and organizes the verified mode information into a fifth data structure and returns the fifth data structure to the operating system.

Specifically, in Embodiment 2, the fourth function is CardGetProperty, the input parameter includes the fifth data structure, and organizing the fifth data structure and returning the fifth data structure to the operating system specifically is that the device driver obtains a verified policy identification from the received verified mode information returned from the smart key, and determines whether the verified mode is verifying a fingerprint according to the verified policy identification, if yes, sets the verified type as a first preset value; otherwise, sets the verified type as a second preset value, and organizes the fifth data structure according to the set verified type, and returns the fifth data structure to the operating system;
in which, that the verified type is set as the first preset value means that the login verified mode is verifying a fingerprint; the login verified mode is verifying a PIN code if the verified type is set as the second preset value;
in which, the verified policy identification is TouchPolicy; the verified type is PinType; the first preset value is ExternalPinType; the second preset value AuthenticationPin;
for instance, the fifth data structure PIN INFO is:

| typedef struct _PIN_INFO | |
|---|---|
| { | |
| DWORD | dwVersion; |
| SECRET_TYPE | PinType; |
| SECRET_PURPOSE | PinPurpose; |
| PIN_SET | dwChangePermission; |
| PIN_SET | dwUnblockPermission; |
| PIN_CACHE_POLICY | PinCachePolicy; |
| DWORD | dwFlags; |

} PIN_INFO, *PPIN_INFO;

Step 108, the operating system determines a type of the login verification via the returning value of the fourth function, the operating system invokes the fifth function according to the fifth function pointer and executes Step 109 if the type of the login verification is the first preset value; otherwise, ends the method.

In Embodiment 2, the method further includes the operating system organizes a login interface window handle according to the verification type in the fifth data structure; and
the operating system makes the login interface window handle obtained by organizing as a parameter and input the parameter in the case that the fifth function is invoked.

Step 109, in the case that the fifth function is invoked, the device driver obtains the login interface window handle from the fifth function parameter, and stores the login interface window handle into the second data structure, and returns an invoke response value to the operating system.

Specifically, in Embodiment 2, the fifth function is CardSetProperty, the input parameter is the first data structure and the login interface window handle, storing the login interface window handle into the second data structure specifically is that the device driver stores the login interface window handle into the second data structure which is in the first data structure.

Step 110, the operating system obtains and displays all of the user certificates, prompts the user to choose a certificate which is used for login; the operating system invokes a corresponding sixth function according to the sixth function pointer, and executes Step 111 when receiving the certificate which is used by the user for login.

Step 111, in the case that the sixth function is invoked, the device driver pops up the verification box according to the login interface window handle in the second data structure to prompt the user to input PIN code, and sends the instruction for verifying the PIN code to the smart key when receiving the PIN code input by the user; the device driver receives verified result data, and determines whether above verification is successful, if yes, executes Step 112; otherwise, prompts the verification is unsuccessful.

Specifically, in Embodiment 2, the sixth function is CardAuthenticateEx.

Preferably, the device driver prompting the PIN code is verified unsuccessfully specifically includes that the device driver determines whether a number of left times for inputting the PIN code is 0, if yes, prompts the smart key is locked, ends the method; otherwise, waits for receiving the PIN code input by the user.

Step 112, the device driver prompts the user to input fingerprint information in the smart key for verification, and sends the instruction for verifying a fingerprint to the smart key; the device driver receives verified result data, determines whether the verification is successful, if yes, returns verification successful information to the operating system, and executes Step 113; otherwise, prompts the verification is unsuccessful.

Preferably, the device driver prompting the fingerprint is verified unsuccessfully specifically includes the device driver determines whether a number of left times for verifying fingerprint is 0, if yes, prompts the smart key is locked, ends the method; otherwise, waits for receiving fingerprint information input by the user.

Step 113, the operating system invokes the seventh function according to the seventh function pointer, and executes Step 114.

Specifically, in Embodiment 2, the seventh function is CardSignData; the system makes a container index, a signature algorithm identification and data being signed as parameters to invoke the seventh function.

Step 114, in the case that the seventh function is invoked, the device driver sends data being signed to the smart key, the smart key uses a parameter of the seventh function to locate a signature private key and a signature algorithm, and generates credential information which is needed by the login operating system by operating on the data being signed according to the signature algorithm by using the signature private key, and the device driver returns the credential information to the operating system.

Specifically, in Embodiment 2, in which, the smart key using the parameter to locate the signature private key and the signature algorithm of the seventh function includes that the smart key obtains the signature private key and the signature algorithm from the corresponding container according to the container index and the signature algorithm identification in the parameters of the seventh function; and returns signing unsuccessful information to the operating system if the smart key signs unsuccessfully, and the seventh function returns error information.

For instance, in Embodiment 2, the data being signed includes a user name, a domain name, and a random number, etc.;
for instance, the credential information is:

```
typedef struct _CARD_SIGNING_INFO
{
  DWORD dwVersion;
  BYTE bContainerIndex;
  // See dw smart key Spec constants
  DWORD dw smart key Spec;
  // If CARD_BUFFER_SIZE_ONLY flag is present then the card
  // module should return only the size of the resulting
  // smart key in cbSignedData
  DWORD dwSigningFlags;
  // If the aiHashAlg is non zero, then it specifies the algorithm
  // to use when padding the data using PKCS
  ALG_ID aiHashAlg;
  // This is the buffer and length that the caller expects to be signed.
  // Signed version is allocated a buffer and put in cb/pbSignedData. That should
  // be freed using PFN_CSP_FREE callback.
  PBYTE pbData;
  DWORD cbData;
  PBYTE pbSignedData;
  DWORD cbSignedData;
  // The following parameters are new in version 2 of the
  // CARD_SIGNING_INFO structure.
  // If CARD_PADDING_INFO_PRESENT is set in dwSigningFlags then
  // pPaddingInfo will point to the BCRYPT_PADDING_INFO structure
  // defined by dwPaddingType. Currently supported values are
  // CARD_PADDING_PKCS1, CARD_PADDING_PSS and CARD_PADDING_NONE
  LPVOID pPaddingInfo;
  DWORD dwPaddingType;
} CARD_SIGNING_INFO, *PCARD_SIGNING_INFO;
```

Step 115, the operating system determines whether a calculation signature is successful via the returning value of the seventh function, if yes, executes Step 116; otherwise, prompts login failure, ends the method.

Specifically, in Embodiment 2, the calculation signature is successful if the seventh function returns the credential information; otherwise, the calculation signature fails.

Step 116, the operating system verifies the credential information by using the certificate chosen by the user, executes Step 117 if the credential information is verified successfully; otherwise, rejects login.

Specifically, in Embodiment 2, verifying a signature result by using the certificate chosen by the user specifically is that the operating system decrypts the signature result by using the signature public key in the certification chosen by the user, and operates hash algorithm on the data being signed, determines whether a hash algorithm result is the same as the decrypted result, if yes, the verification is successful; otherwise, the verification is unsuccessful.

Step 117, the operating system invokes the corresponding eighth function according to the eighth function pointer, and executes Step 118.

Step 118, in the case that the eighth function is invokes, the device driver sends encrypted data to the smart key, the smart key uses a parameter of the eighth function to locate a decrypted private key and a decrypted algorithm, and generates verified data which is needed for login the operating system by operating algorithm on the encrypted data according to the decrypted algorithm by using the decrypted key, and the device driver returns the verified data to the operating system.

Specifically, in Embodiment 2, the eighth function is CardRSADecrypt; the system makes the container index, the encrypted algorithm identification and the encrypted data as parameters to invokes the eighth function.

For instance, the verified data is

```
typedef struct _CARD_RSA_DECRYPT_INFO
{
  DWORD dwVersion;
  BYTE bContainerIndex;
  // For RSA operations, this should be AT_SIGNATURE or AT_smart key EXCHANGE.
  DWORD dw smart key Spec;
  // This is the buffer and length that the caller expects to be decrypted.
  // For RSA operations, cbData is redundant since the length of the buffer
  // should always be equal to the length of the smart key modulus.
  PBYTE pbData;
  DWORD cbData;
  // The following parameters are new in version 2 of the
  // CARD_RSA_DECRYPT_INFO structure.
  // Currently supported values for dwPaddingType are
  // CARD_PADDING_PKCS1, CARD_PADDING_OAEP, and CARD_PADDING_NONE.
  // If dwPaddingType is set to CARD_PADDING_OAEP, then pPaddingInfo
  // will point to a BCRYPT_OAEP_PADDING_INFO structure.
  LPVOID  pPaddingInfo;
  DWORD  dwPaddingType;
} CARD_RSA_DECRYPT_INFO, *PCARD_RSA_DECRYPT_INFO;
```

Step 119, the operating system verifies the verified data, if the verified data is verified successfully, login is permitted; otherwise, reject to login.

Specifically, in Embodiment 2, the operating system verifying the verified data specifically is the operating system determines whether the verified data is the same as the data which is not decrypted, if yes, the verified data is verified successfully; otherwise, the verified data is verified unsuccessfully.

In Embodiment 2, the smart key claims itself is a USB device when it is inserted into the operating system;

Furthermore, the smart key can be replaced with a smart card, in which, the smart card can also realize the program provided in Embodiment 2 as the smart key when the smart card is inserted in the operating system via a card reader.

### Embodiment 3

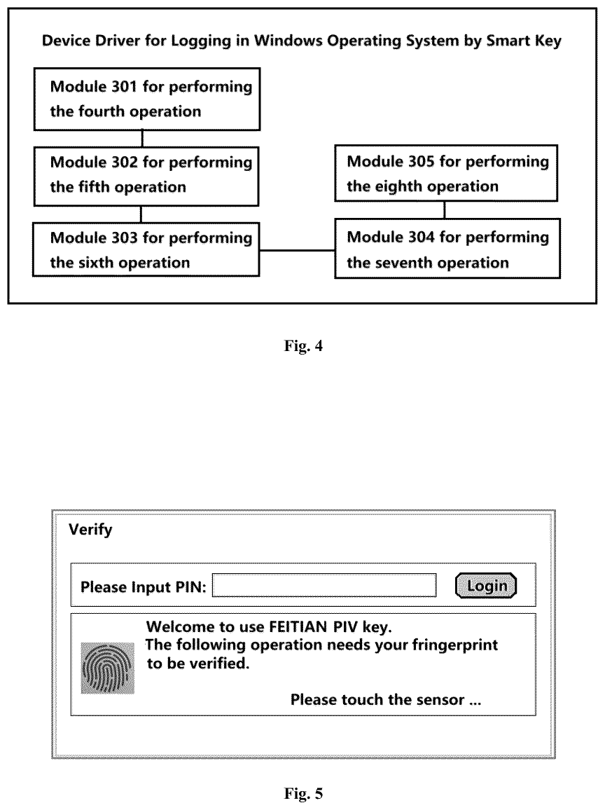

According to Embodiment 3, as shown in FIG. 4, the device driver includes that a fourth operation module 301 (a module for performing a fourth operation 301), a fifth operation module 302 (a module for performing a fifth operation 302), a sixth operation module 303 (a module for performing a sixth operation 303), a seventh operation module 304 (a module for performing a seventh operation 304), and an eighth operation module 305 (a module for performing an eighth operation 305), in which
the fourth operation module 301 is configured to send an instruction for obtaining a login verification mode to the smart key, and to receive verification mode information returned from the smart key, and organize the verification mode information into a fifth data structure and return the fifth data structure to the operating system;
the fifth operation module 302 is configured to obtain a login interface window handle in a fifth function parameter, and to store the login interface window handle into a second data structure, and return an invoking response value to the operating system;
the sixth operation module 303 is configured to pop up a verification box according to the login interface window handle in the second data structure stored by the fifth operation module, and to prompt the user to input a PIN code, receive the PIN code input by the user, and send an instruction for verifying the PIN code to the smart key;
the sixth operation module 303 is further configured to receive PIN code verified result data returned from the smart key, determine whether the PIN code is verified successfully, if yes, prompt the user to input biological feature information in the smart key for verification, and send an instruction for verifying a biological feature; otherwise, prompt the PIN code verified unsuccessfully;
the sixth operation module 303 is further configured to receive biological feature verified result data returned from the smart key, and determine whether the biological feature is verified successfully, if yes, return verification successful information to the operating system; otherwise, prompt biological feature verified unsuccessfully;
the seventh operation module 304 is configured to send data being signed to the smart key, and receive signed data returned from the smart key, and organize the signed data into credential information and return the credential information to the operating system; and
the eighth operation module 305 is configured to send encrypted data to the smart key, and receive decrypted data returned from the smart key, and organize the decrypted data into verification data and return the verification data to the operating system.

Preferably, in Embodiment 3, the fourth operation module 301 is specifically configured to obtain a verification policy identification from the received verification mode information returned from the smart key, and determine whether the biological feature is verified according to the verification policy identification, if yes, set a verification type as a first preset value; otherwise, set the verification type as a second preset value, and organize the fifth data structure according to the set verification type, return the fifth data structure to the operating system, and then the operating system organizes the login interface window handle according the verification type in the fifth data structure.

Preferably, in Embodiment 3, the device driver further includes a third operation module;
the third operation module is configured to send an instruction for obtaining public key information of an appointed index container according to a parameter input by the operating system, and receive the public key information returned from the smart key, and organize the public key information into a fourth data structure and return the fourth data structure to the operating system.

Preferably, in Embodiment 3, the device driver further includes a second operation module;
the second operation module is configured to obtain a parameter file name introduced by the operating system, send an instruction for obtaining file information to the smart key according to the file name, and receive the file information returned from the smart key, and organize the file information into a third structure data and return the third structure data to the operating system.

Preferably, in Embodiment 3, the second operation module is specifically configured to obtain the introduced parameter file name, determine the obtained file name, in the case that the file name is a first file name, send an instruction for obtaining a smart key serial number to the smart key according to the first file name, and receive first file information returned from the smart key, and obtain the serial number from the first file information, and organize the third data structure according to the serial number and return the third data structure to the operating system.

Preferably, in Embodiment 3, the second operation module is specifically configured to obtain the introduced parameter file name, determine the obtained file name, in the case that the file name is a second file name, send an instruction for obtaining a certificate stored in the smart key to the smart key according to the second file name, and receive certificate information returned from the smart key, and organize the obtained certificated information into the third data structure and return the third data structure to the operating system.

Preferably, in Embodiment 3, the second operation module is specifically configured to obtain the introduced parameter file name, and determine the file name, in the case that the file name is a third file name, organize the obtained certificate content into data structure and return the data structure to the operating system.

Preferably, in Embodiment 3, the device driver further includes a first operation module;
the first operation module is configured to return a function address list to the operating system.

Preferably, in Embodiment 3, the first operation module is specifically configured to initial the first data structure, obtain a second function address, a third function address, a fourth function address, a fifth function address, a sixth function address, a seventh function address, and an eighth function address, build the second data structure which is defined by a manufacturer itself and store the second data structure into the first data structure, and return the first data structure to the operating system.

According to the present invention, a user can login Windows system more safely by combining an outside PIN code verification with a fingerprint verification in Windows function.

The Windows operating system invokes the fifth function and the sixth function one by one.

The fifth function saves a parent window handle, while the sixth function pops up a verification box according to the parent window handle.

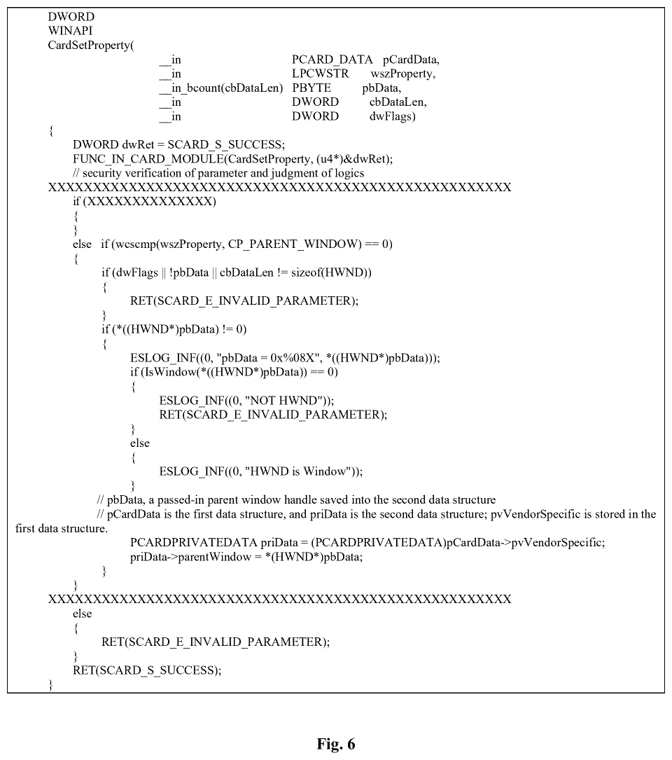

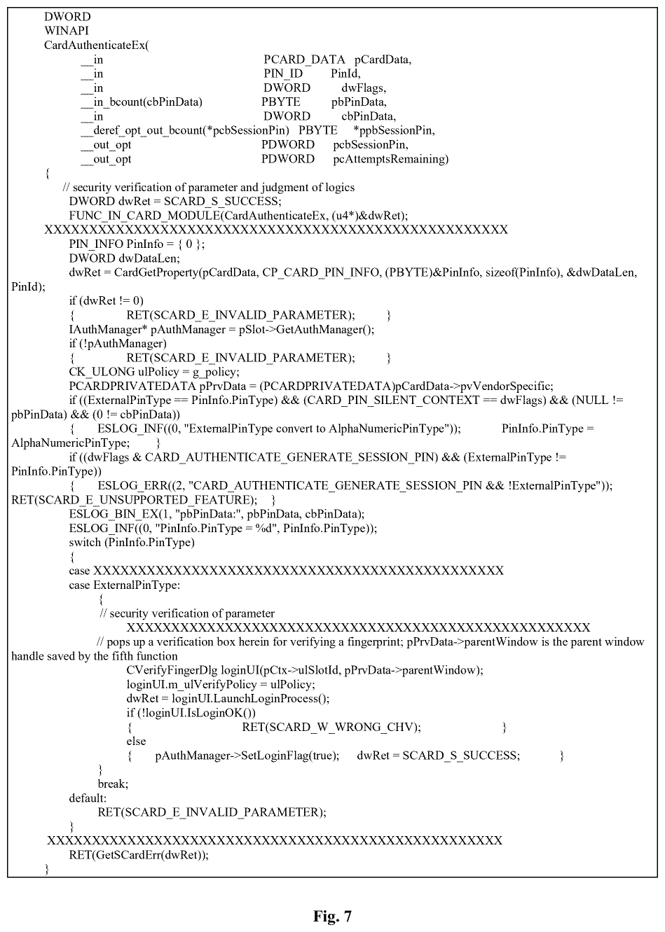

As one embodiment, the fifth function and the sixth function are used in a way as shown in FIG. 6 and FIG. 7, respectively.

The above is an introduction of a method and a device driver for a smart key to login a Windows operating system according to the present invention, and the above embodiments just help to understand the concept in the present invention; meanwhile, any changes developed by techniques in the field belongs to the scope of the present invention.

1. A method for performing dual verification to login into a Windows operating system, wherein the method is implemented using a device driver of a smart key, the method comprises:
in the case that a first function of the device driver is invoked by the Windows operating system, initializing, by the device driver, a first data structure; storing a second data structure into the first data structure, and returning the first data structure to the Windows operating system;
in the case that a sixth function of the device driver is invoked by the Windows operating system, popping up, by the device driver, a verification box according to a login interface window handle in the second data structure, prompting a user to input both a PIN code and biological feature information; and
in the case that both the PIN code and the biological feature information are verified successfully, permitting, by the Windows operating system, logging into the Windows operating system.

2. The method of claim 1, wherein
the first function is a CardAcquireContext function implemented as defined in the Smart Card Minidriver Specification of the Windows operating system;
the sixth function is a CardAuthenticateEx function implemented as defined in the Smart Card Minidriver Specification of the Windows operating system;
the second data structure is self-defined, the login interface window handle is a parameter obtained when a fifth function of the device driver is invoked by the Window operating system.

3. The method of claim 1, wherein
the Windows operating system is running on a Personal Computer;
the device driver is a minidriver of the smart key; and/or
the verification box popped up by the device driver comprises text information, prompting the user to input both the PIN code and biological feature information during a login process of the Windows operating system.

4. The method of claim 1, wherein the method applies to the device driver, the Windows operating system and the smart key; in which the device driver comprises the first function, a fourth function, a fifth function, the sixth function, a seventh function and an eighth function,
in the case that the fourth function of the device driver is invoked by the Windows operating system, sending, by the device driver, to the smart key an instruction for obtaining a login verification mode which is used to determine both the PIN code and the biological feature information are verified to the smart key during a login process of the Windows operating system, receiving verification mode information returned from the smart key, and organizing, by the device driver, the verification mode information into a fifth data structure and returning the fifth data structure to the Windows operating system;
in the case that the fifth function of the device driver is invoked by the Window operating system, obtaining, by the device driver, a login interface window handle in a fifth function parameter, storing the login interface window handle into the second data structure, and returning an invoking response value to the Windows operating system;
in the case that the sixth function of the device driver is invoked by the Windows operating system, popping up, by the device driver, a verification box according to the login interface window handle in the second data structure, prompting the user to input the PIN code, and sending an instruction for verifying the PIN code to the smart key when the PIN code input by the user is received;
in the case that the device driver receives PIN code verified result data returned from the smart key, determining, by the device driver, whether the PIN code is verified successfully, if yes, prompting the user to further input the biological feature information into the smart key for an additional verification, and sending an instruction for verifying a biological feature to the smart key; otherwise, prompting the PIN code is verified unsuccessfully;
in the case that the device driver receives the biological feature verified result data returned from the smart key, determining, by the device driver, whether the biological feature is verified successfully, if yes, returning verification successful information to the Windows operating system; otherwise, prompting the biological feature is verified unsuccessfully;
in the case that the seventh function of the device driver is invoked by the Windows operating system, sending, by the device driver, data signed to the smart key, receiving the signed data returned from the smart key, and organizing the signed data into credential information, and returning the credential information to the Windows operating system;
in the case that the eighth function of the device driver is invoked by the Windows operating system, sending, by the device driver, encrypted data to the smart key, receiving decrypted data returned from the smart key, and organizing the decrypted data into verified data, and returning the verified data to the Windows operating system; and
in the case that the verified data is verified successfully, permitting, by the Windows operating system, the user to login into the Windows operating system.

5. The method of claim 4, wherein
in the case that login triggering information is received, prompting, by the Windows operating system, the user to insert the smart key into a personal computer;
in the case that the smart key is detected, invoking, by the Windows operating system, the first function;
the device driver of the smart key comprises the first function, the fourth function, the fifth function, the sixth function, the seventh function and the eighth function; and/or
in the case that the first function of the device driver is invoked by the Windows operating system, initializing, by the device driver, the first data structure, obtaining a fourth function address, a fifth function address, a sixth function address, a seventh function address and an eighth function address; then building the second data structure self-defined.

6. The method of claim 4, wherein the method specifically comprises: obtaining, by the device driver, a verification policy identification from the verification mode information returned from the smart key, and determining whether the verification policy identification is a biological feature verification according to the verification policy identification; if yes, setting a verification type as a first preset value; otherwise, setting the verification type as a second preset value; and organizing the fifth data structure according the set verification type; and returning the fifth data structure to the Windows operating system, so that the Windows operating system organizes the login interface window handle according to the verification type in the fifth data structure.

7. The method of claim 4, wherein the method further comprises: in the case that the third function of the device driver is invoked by the Windows operating system, sending, by the device driver, an instruction for obtaining public key information of an appointed index container to the smart key according to an input or introduced parameter; receiving the public key information returned from the smart key; organizing the public key information into a fourth data structure; and returning the fourth data structure to the Windows operating system.

8. The method of claim 4, wherein the method further comprises: in the case that a second function of the device driver is invoked by the Windows operating system, obtaining, by the device driver, a file name of an input or introduced parameter; sending an instruction for obtaining file information to the smart key according to the file name; receiving the file information returned by the smart key; organizing a third structure data according to the file information; and returning the third structure data to the Windows operating system.

9. The method of claim 8, wherein the method specifically comprises: obtaining, by the device driver, a file name of the input or introduced parameter; determining the file name obtained; sending, by the device driver, an instruction for obtaining a smart key serial number to the smart key according to a first file name in the case that the file name is the first file name; receiving first file information returned from the smart key; obtaining a serial number in the first file information; organizing a third data structure according to the serial number; and returning the third data structure to the Windows operating system in the case that the file name is the first file name.

10. The method of claim 8, wherein the method specifically comprises: obtaining, by the device driver, a file name of the input or introduced parameter; determining the file name obtained; sending, by the device driver, an instruction for obtaining a certificate stored in the smart key to the smart key according to a second file name in the case that the file name is the second file name; receiving certificate information returned from the smart key; organizing the certificate information into a third data structure; and returning the third data structure to the Windows operating system.

11. The method of claim 8, wherein the method specifically comprises: obtaining, by the device driver, a file name of the input or introduced parameter; determining the file name obtained; organizing, by the device driver, an obtained certificate content into a data structure; and returning the data structure to the Windows operating system in the case that the file name is a third file name.

12. The method of claim 4, wherein the method further comprises: returning, by the device driver, a function address list to the Windows operating system in the case that the first function of the device driver is invoked by the Windows operating system.

13. The method of claim 1, wherein the second data structure is self-defined by a manufacturer of the smart key, the second data structure is with a default invalid value before the fifth function of the device driver is invoked by the Window operating system.
